(19) United States
(12) Patent Application Publication
(10) Pub. No.: US 2014/0358651 A1
(43) Pub. Date: Dec. 4, 2014

(54) PRESENTING OFFERS FOR IN-GAME VIRTUAL REWARDS

(71) Applicant: KABAM, INC., San Francisco, CA (US)

(72) Inventors: James KOH, Mountain View, CA (US); Kellen Christopher Smalley, Pleasanton, CA (US); Riccardo Fabi, San Francisco, CA (US)

(73) Assignee: KABAM, INC.

(21) Appl. No.: 13/907,664

(22) Filed: May 31, 2013

(51) Int. Cl. G06Q 30/02

(52) U.S. Cl. CPC G06Q 30/0209
USPC 705/14.12

(57) ABSTRACT

This disclosure relates to presenting offers for in-game virtual rewards to users. In implementations, rewards of virtual currency associated with the offers may be determined on a per user basis, such that a reward of virtual currency associated with an offer is incremented until the user accepts the offer and performs an action associated with the offer.

### FIELD OF THE DISCLOSURE

This disclosure relates to presenting offers for in-game virtual rewards, where offers including rewards of virtual currency are incremented until a user accepts the offer.

### BACKGROUND

The popularity of online games has grown over the years. Conventional online games are provided through gaming platforms, such as Facebook.com, Kabam.com, Zynga.com, Bigpoint Games, Steam, etc. Online game providers may present offers to users of the online game via an offer wall in a webpage or mobile interface. The offers presented to users of the online game may include a number of different activities that can be performed by the users in exchange for rewards. The offers may include activities such as applying for a credit card, subscribing to a streaming content service (e.g., Netflix®), taking a survey, watching a promotional video, and/or other activities. Conventionally, offer walls are offered by online game providers where users of the online game may perform the activity associated with an offer in exchange for in-game rewards which they would otherwise have to purchase with real world currency.

Conventionally, offers within an offer wall are provided to the online game provider by an offer broker. The offer broker may have a relationship with the online game provider and with the entities associated with the activities to be performed (e.g. the credit card company, Netflix®, the survey provider, etc.). The offer broker may negotiate deals with such entities where the offer broker is paid a certain amount of money for each person who performs a certain desired activity. The offer broker may then share these deals with one or more game providers, which can create offers from the deals and place them on an offer wall. When a user completes an activity associated with an offer, the offer broker receives real world currency per the broker's deal with the entities, a portion of which is shared with the game provider, and the user may receive an in-game reward from the online game provider.

Conventionally, the in-game rewards presented to the user of the online game provider are fixed. Therefore, if an offer to a user to subscribe to a streaming media provider is presented to the user through the offer wall, the virtual reward presented to the user remains the same over time. Thus, if the user is disinclined to take an action for a virtual reward associated with an offer from the online game provider, the offer may use valuable virtual real estate on the offer wall. Additionally, the user may have performed the action for a virtual reward that is less than the presented virtual reward. However, with conventional offer walls there is no way of determining if the user would have performed the activity associated with an offer for a virtual reward that is less than the presented virtual reward.

Accordingly, alternative approaches for presenting offers within an offer wall may encourage users to perform activities associated with the offers and at low cost to the game provider.

### SUMMARY

One aspect of this disclosure relates to incrementing a reward of virtual currency associated with an offer that is presented to a user of an online gaming platform until the user accepts the offer and performs an action associated with the offer. In contrast, conventional virtual rewards within an offer presented to a user of an online gaming platform remain static. Thus, a virtual reward within an offer may be changed to encourage users to perform an action associated with the offer.

In implementations, a system may include one or more processors configured to execute computer program modules. The computer program modules may include a space module, an offer reception module, an offer presentation module, a revenue module, a reward module, and a reward distribution module.

The space module may be configured to execute an instance of a virtual space. The space module may also be configured to use the instance of the virtual space to facilitate interaction with the virtual space by users via client computing devices.

The offer reception module may be configured to receive information associated with one or more offers from one or more offer providers. In implementations, the offers may include a first offer from a first offer provider. The first offer may be associated with a first action, a first reward of virtual currency usable in the virtual space, and a first amount of revenue.

The offer presentation module may be configured to effectuate presentation of the offers to a first user on a first client computing device.

The revenue module may be configured to receive revenue from the offer providers based on the users participating in the offers such that responsive to the first user accepting the first offer and performing the first action, the revenue module may be configured to receive the first amount of revenue from the first offer provider associated with the first offer.

The reward distribution module may be configured to distribute rewards to users for participating in the offers such that responsive to the first user accepting the first offer and performing the first action, the reward distribution module may be configured to distribute the first reward to the first user.

In implementations, the revenue module is further configured to transmit users' indications of acceptance to offer providers such that responsive to the first user accepting the first offer an indication of acceptance of the first offer by the first user is transmitted to the first offer provider.

In implementations, the reward module is configured to increment the first reward based on an amount of time elapsed since the first reward was presented to the first user, a number of offer views by the first user, and/or other parameters.

In implementations, the reward module is further configured to stop incrementing the first reward once it reaches a maximum reward threshold. In implementations, responsive to the first reward being incremented to reach the maximum reward threshold, the revenue module is configured to transmit an offer provider request to the first offer provider. The offer provider request may include a request for an increase in revenue from the first offer provider based on the first user accepting the first offer and performing the first action. In implementations, responsive to the revenue module transmitting the offer provider request, the revenue module may be configured to receive an offer provider acceptance increasing the revenue received from the first offer provider based on the first user accepting the first offer and performing the first action.

In implementations, the reward module may be configured to increase the maximum reward threshold responsive to receipt of the offer provider acceptance.

In implementations, the offer presentation module is configured to remove the first offer from the offers presented to the first user based on the first user participating in the first offer.

These and other features and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural references unless the context clearly dictates otherwise.

### BRIEF DESCRIPTION OF THE DRAWINGS

FIG. 1 illustrates a system configured to presenting offers for in-game virtual rewards, in accordance with one or more implementations.

FIG. 2 illustrates a method of presenting offers for in-game virtual rewards, in accordance with one or more implementations.

FIG. 3 illustrates a method of presenting offers for in-game virtual rewards, in accordance with one or more implementations.

FIG. 4 illustrates a screenshot of presenting offers for in-game virtual rewards, in accordance with one or more implementations.

### DETAILED DESCRIPTION

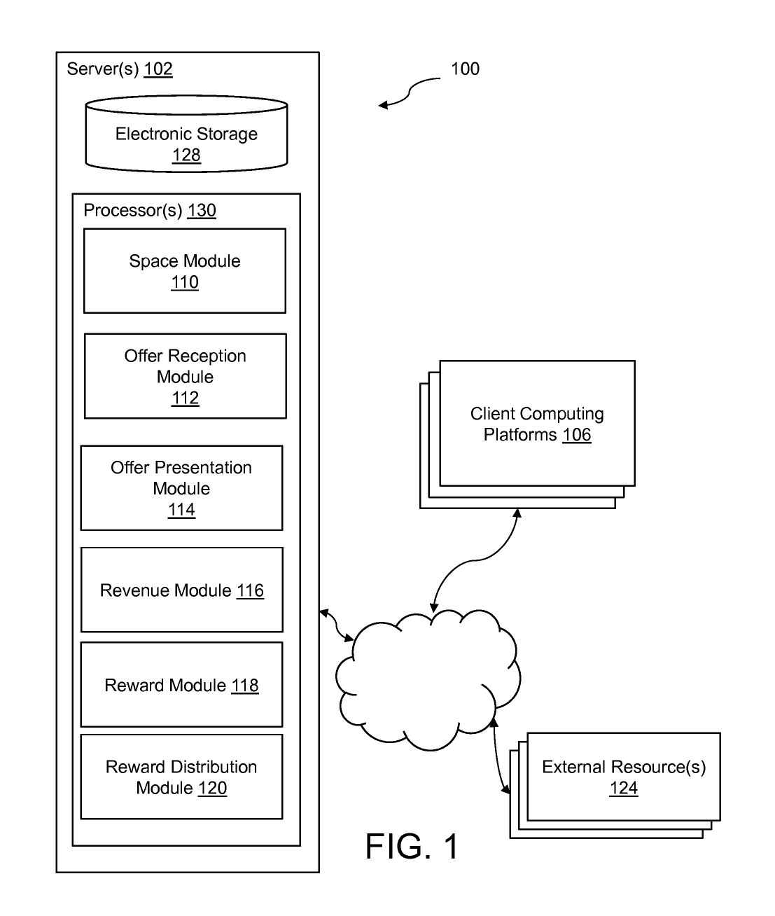

FIG. 1 illustrates a system 100 configured to provide a virtual space to users. Providing the virtual space may include hosting the virtual space over a network. In some implementations, system 100 may include one or more servers 102. The server(s) 102 may be configured to communicate with one or more client computing platforms 106 according to a client/server architecture. The users may access system 100 and/or the virtual space via client computing platforms 106, to engage in one or more online games, in addition to other activities.

System 100 is only one example of a suitable computing environment and is not intended to suggest any limitation as to the scope of use or functionality of the features described herein. Providing the virtual space may include hosting the virtual space over a network. In this disclosure, a user of an online game may be presented with an offer with virtual currency that is incremented until the user accepts the offer and performs an action associated with the offer.

Server(s) 102 may be configured to host one or more online games for one or more gaming providers or games hosted on server(s) 102, and to execute one or more computer program modules associated with the online games to provide access to the online games to a plurality of users. The computer program modules may include one or more of a space module 110, an offer reception module 112, an offer presentation module 114, a revenue module 116, a reward module 118, and a reward distribution module 120. As noted, the client computing platforms 106 may include one or more computer program modules that are the same as or similar to the computer program modules of the server(s) 102 to facilitate actions.

Space module 110 may be configured to implement the instance of the virtual space executed by the modules. The instance of the virtual space may reflect the state of the virtual space. The instance of the virtual space may be used to push state information to clients for implementation on the clients, may be used to verify state information generated on clients executing expressions of the instance locally, and/or for other purposes. State information may include information about the state of the virtual space such as, without limitation, position information of one or more objects, topography information, object status/shape information, battle information, score information, user or character progress information, user inventory information, progress information for one or more activities or actions, view information describing a view of the virtual space, and/or other information that describes the state of the virtual space. Expressions of the instance executed on the clients facilitate presentation of views on the clients of the virtual space. Expressions of the instance executed on the clients may be configured to simply present views of the virtual space based on the state information (e.g., via streaming view information, object/position information, and/or other state information) received from space module 110. Expressions of the instance executed on the client computing platforms 106 may include space logic that effectively provides for execution of a limited version of the instance on a client that is synchronized and/or verified with state information received from space module 110. The view presented on a given client may correspond to a location in the virtual space (e.g., the location from which the view is taken, the location the view depicts, and/or other locations), a zoom ratio, a dimensionality of objects, a point-of-view, and/or view parameters. One or more of the view parameters may be selectable by the user.

The instance of the virtual space may comprise a simulated space that is accessible by users via client computing platforms 106 that present the views of the virtual space to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the space. In some instances, the topography may describe a surface (e.g., a ground surface) that runs through at least a substantial portion of the space. In some instances, the topography may describe a volume with one or more bodies positioned therein (e.g., a simulation of gravity-deprived space with one or more celestial bodies positioned therein). The instance executed by the modules may be synchronous, asynchronous, and/or semi-synchronous.

The above description of the views of the virtual space determined from the instance executed by space module 110 is not intended to be limiting. The virtual space may be presented in a more limited, or more rich, manner. For example, views of the virtual space may be selected from a limited set of graphics depicting an event in a given place within the virtual space. The views may include additional content (e.g., text, audio, pre-stored video content, and/or other content) that describes particulars of the current state of the place, beyond the relatively generic graphics. For example, a view may include a generic battle graphic with a textual description of the opponents to be confronted. Other representations of individual places within the virtual space are contemplated.

Within the instance of the virtual space executed by space module 110, users may control characters, objects, simulated physical phenomena (e.g., wind, rain, earthquakes, and/or other phenomena), and/or other elements within the virtual space to interact with the virtual space and/or each other. The user characters may include avatars. As used herein, the term “user character” may refer to an object (or group of objects) present in the virtual space that represents an individual user. The user character may be controlled by the user with which it is associated. The user controlled element(s) may move through and interact with the virtual space (e.g., non-user characters in the virtual space, other objects in the virtual space). The user controlled elements controlled by and/or associated with a given user may be created and/or customized by the given user. The user may have an “inventory” of virtual goods and/or currency that the user can use (e.g., by manipulation of a user character or other user controlled element, and/or other items) within the virtual space.

The users may participate in the instance of the virtual space by controlling one or more of the available user controlled elements in the virtual space. Control may be exercised through control inputs and/or commands input by the users through client computing platforms 106. The users may interact with each other through communications exchanged within the virtual space. Such communications may include one or more of textual chat, instant messages, private messages, voice communications, and/or other communications. Communications may be received and entered by the users via their respective client computing platforms 106. Communications may be routed to and from the appropriate users through server 102 (e.g., through space module 110).

Offer reception module 112 may be configured to receive information associated with one or more offers from one or more offer providers. The offers may be associated with actions that the user may engage in, virtual rewards usable in the virtual space, and amounts of revenue. In implementations, the virtual reward may be virtual currency configured to be used within an on-line game. When the offers are accepted by users that perform the associated actions, the users performing the actions may receive the virtual rewards and the game provider may receive the amounts of revenue. For example, the offers may involve associated actions such as applying for a credit card, subscribing to a streaming content service, taking a survey, watching a promotional video, and/or other activities. In implementations, the offer providers may be offer brokers having relationships with the entities that want the user to perform the actions within the offers. In further implementations, the offer brokers may themselves be the entities that want the user to perform the actions. For example, a credit card company or an offer broker may communicate an offer to offer reception module 112 with an amount of revenue that is received by the game provider for each user that fills out an online credit card application. The game provider may then select an amount of virtual currency a user will receive as a reward for participating in the offer (e.g. using modules described below).

Offer presentation module 114 may be configured to effectuate presentation of offers to users on client computing devices 106. In implementations, offer presentation module 114 may be configured to present the offers within an offer wall, where the offer wall includes a plurality of offers. Offer presentation module 114 may present the offer wall to users within a webpage, a mobile interface, etc. associated with an online game provider. The offers presented to the users may include actions that the user may engage in and rewards of virtual currency usable in the virtual space associated with each offer. Offer presentation module 114 may dynamically present the offers to the users, such that over time the reward for virtual currency associated with each offer may be updated in real time, different users may be presented with different offers, and an offer presented to a first user in the offer wall may be removed from the offer wall based on the first user participating in the offer.

Revenue module 116 may be configured to receive revenue from the offer providers based on the users participating in the offers. In implementations, responsive to the user accepting a first offer and performing a first action associated with the offer, revenue module 116 is configured to receive an amount of revenue from the offer provider associated with the offer that the user participates in. Revenue module 116 may be further configured to transmit users' indications of acceptations to offer providers, such that responsive to the user accepting the first offer an indication of acceptance of the first offer by the first user is transmitted to the offer provider associated with the first offer.

Reward module 118 may be configured to determine the rewards of virtual currency associated with the offers on a per user basis. For example, reward module 118 may determine that a reward of virtual currency associated with an offer is incremented until a user accepts the offer and performs an action associated with the offer. In implementations, reward module 118 may be further configured to increment the reward of virtual currency associated with an offer based on an amount of time elapsed since the reward of virtual currency was first presented to a user, a number of views of the offer by a user, and/or other parameters. Reward module 118 may increment the reward of virtual currency until the either the offer is accepted or the reward reaches a maximum reward threshold. The maximum reward threshold may be associated with a dynamic amount of virtual currency that the game provider associated with the virtual currency desires to be associated with an offer or may be associated with any other metric. Although rewards of virtual currency may in a sense be costless to a game provider, since virtual currency can be created by the game provider as desired, a maximum may be desirable to prevent excessive inflation within an online game and to reduce gaming of the dynamic rewards. Excessive inflation may reduce the value of users' real money purchases and require adjustments of various in-game prices.

Reward distribution module 120 may be configured to distribute virtual rewards to users for participating in the offers such that, responsive to a user accepting an offer and performing an action associated with the offer, reward distribution module 120 may be configured to distribute a reward associated with the offer to the user.

In implementations, responsive to the reward for an offer being incremented to the maximum reward threshold, revenue module 116 may be configured to transmit an offer provider request to the offer provider associated with the offer. The offer provider request may include a request for an increase in revenue from the offer provider based on the user accepting the offer and performing the first action associated with the offer. Responsive to revenue module 116 transmitting the offer provider request, revenue module 116 may be configured to receive an offer provider acceptance increasing the revenue received from the offer provider associated with the offer based on the user accepting the offer and performing the associated action. If revenue module 116 receives the offer provider acceptance from the offer provider, then reward module 118 may be configured to increase the maximum reward threshold for the offer. If revenue module 116 does not receive the offer provider acceptance from the offer provider, then reward module 118 may not increase the maximum reward threshold for the offer.

Therefore, virtual rewards for offers presented through an offer wall are dynamic, such that over time the virtual reward for a given offer is increased incrementally until the virtual reward is sufficient to entice a user to accept the offer and perform the action associated with the offer.

In some implementations, the server(s) 102, client computing platforms 106, and/or external resources 124 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platforms 106, and/or external resources 124 may be operatively linked via some other communication media.

A given client computing platform 106 may include one or more processors configured to execute computer program modules. The computer program modules may be configured to enable an expert or user associated with the given client computing platform 106 to interface with system 100 and/or external resources 124, and/or provide other functionality attributed herein to client computing platforms 106. By way of non-limiting example, the given client computing platform 106 may include one or more of a desktop computer, a laptop computer, a handheld computer, a tablet computing platform, a NetBook, a Smartphone, a gaming console, and/or other computing platforms.

External resources 124 may include sources of information, hosts and/or providers of virtual environments outside of system 100, external entities participating with system 100, and/or other resources. In some implementations, some or all of the functionality attributed herein to external resources 124 may be provided by resources included in system 100.

Server(s) 102 may include electronic storage 128, one or more processors 130, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s).

Electronic storage 128 may comprise non-transitory storage media that electronically stores information. The electronic storage media of electronic storage 128 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 128 may include one or more virtual storage resources (e.g., cloud storage, a virtual private network, and/or other virtual storage resources). Electronic storage 128 may store software algorithms, information determined by processor 130, information received from server(s), information received from client computing platforms 106, and/or other information that enables server(s) to function as described herein.

Processor(s) 130 is configured to provide information processing capabilities in server(s) 102. As such, processor 130 may include one or more of a digital processor, an analog processor, a digital circuit designed to process information, an analog circuit designed to process information, a state machine, and/or other mechanisms for electronically processing information. Although processor 130 is shown in FIG. 1 as a single entity, this is for illustrative purposes only. In some implementations, processor 130 may include a plurality of processing units. These processing units may be physically located within the same device, or processor 130 may represent processing functionality of a plurality of devices operating in coordination. The processor 130 may be configured to execute modules 110, 112, 114, 116, 118, and 120. Processor 130 may be configured to execute modules 110, 112, 114, 116, 118, and 120 by software; hardware; firmware; some combination of software, hardware, and/or firmware; and/or other mechanisms for configuring processing capabilities on processor 130. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 110, 112, 114, 116, 118, and 120 are illustrated in FIG. 1 as being implemented within a single processing unit, in implementations in which processor 130 includes multiple processing units, one or more of modules 110, 112, 114, 116, 118, and 120 may be implemented remotely from the other modules. The description of the functionality provided by the different modules 110, 112, 114, 116, 118, and 120 described below is for illustrative purposes, and is not intended to be limiting, as any of modules 110, 112, 114, 116, 118, and 120 may provide more or less functionality than is described. For example, one or more of modules 110, 112, 114, 116, 118, and 120 may be eliminated, and some or all of its functionality may be provided by other ones of modules 110, 112, 114, 116, 118, and 120. As another example, processor 130 may be configured to execute one or more additional modules that may perform some or all of the functionality attributed below to one of modules 110, 112, 114, 116, 118, and 120.

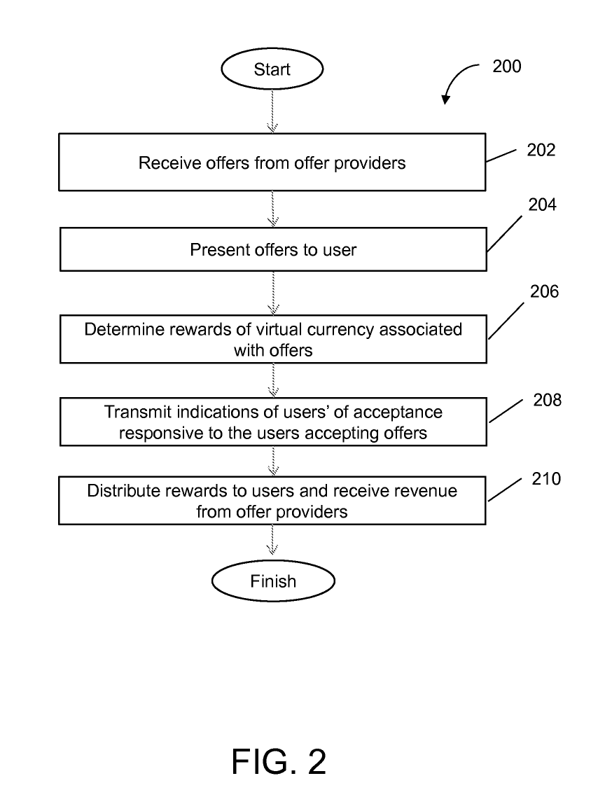

FIG. 2 illustrates a method of presenting offers for in-game virtual rewards to users. The operations of method 200 presented below are intended to be illustrative. In some embodiments, method 200 may be accomplished with one or more additional operations not described, and/or without one or more of the operations discussed. Additionally, the order in which the operations of method 200 are illustrated in FIG. 2 and described below is not intended to be limiting.

In some embodiments, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

At an operation 202, information associated with one or more offers may be received from one or more offer providers. The received offers may be associated with actions, rewards of virtual currency usable in virtual space, and amounts of revenue. The offers may include a first offer having an associated first action, first reward of virtual currency, and first amount of revenue. In implementations, the actions may be associated with products and/or services that the user may purchase or try from a provider of products and/or services, the rewards may be virtual rewards being virtual currency configured to be used within an on-line game, and the amounts of revenue may be amounts of real currency received responsive to the users performing the actions. Operation 202 may be performed by an offer reception module that is the same as or similar to offer reception module 112, in accordance with one or more implementations.

At an operation 204, the received offers may be presented to a first user on a first client computing device. The presented offers may be presented to the user within an offer wall. Operation 204 may be performed by an offer presentation module that is the same as or similar to offer presentation module 114, in accordance with one or more implementations.

At an operation 206, rewards of virtual currency associated with the received offers may be determined on a per user basis, such that the first reward of virtual currency is incremented until the first user accepts the first offer and performs the first action associated with the first offer. In implementations, the virtual reward may be incremented based on an amount of time elapsed since the first reward was first presented to the first user, a number of times the first user has viewed the offer, and/or other parameters. Rewards associated with other offers and presented to other users may be incremented similarly. Operation 206 may be performed by a reward module that is the same as or similar to reward module 118, in accordance with one or more implementations.

At an operation 208, users' indications of acceptance may be transmitted to offer providers. Transmission of an indication of acceptance may be responsive to the first user accepting the first offer and performing the associated first action. Operation 208 may be performed by a revenue module that is the same as or similar to revenue module 116, in accordance with one or more implementations.

At an operation 210, rewards may be distributed to the users for participating in the offers. Responsive to the first user accepting the first offer, revenue may be received from the associated offer provider and the virtual reward associated with the first offer may be distributed to the first user. Operation 210 may be performed by a revenue module and reward distribution module that are the same as or similar to revenue module 116 and reward distribution module 120, in accordance with one or more implementations.

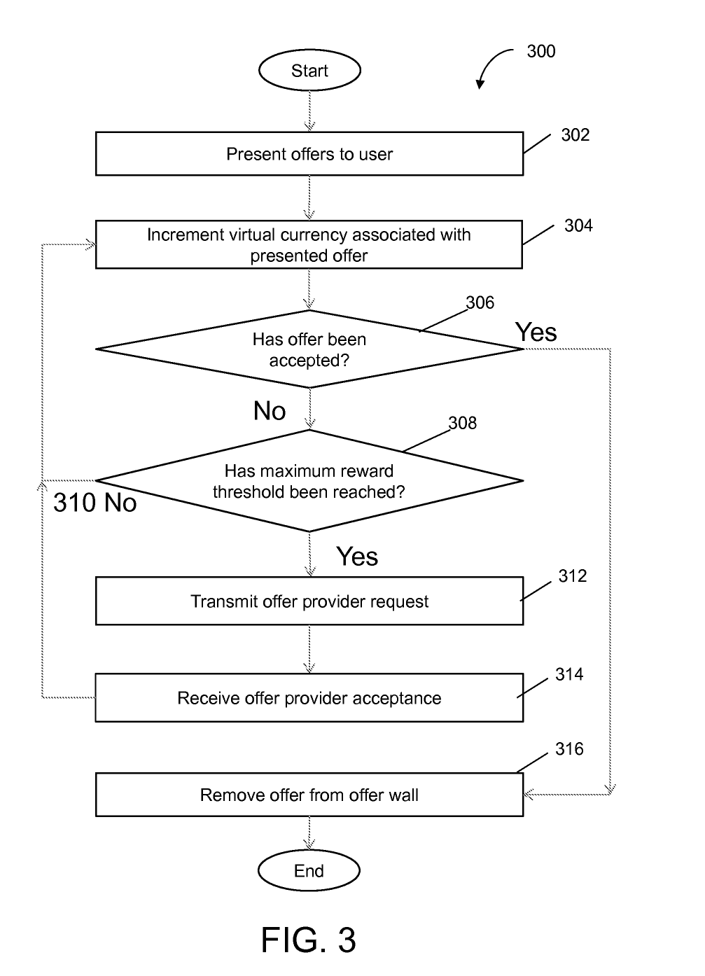

FIG. 3 illustrates a method of presenting offers for in-game virtual rewards to users. The operations of method 300 presented below are intended to be illustrative. In some embodiments, method 300 may be accomplished with one or more additional operations not described, and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At an operation 302, received offers may be presented to a user on a first client computing device. The presented offers may be presented to the user within an offer wall. Operation 302 may be performed by an offer presentation module that is the same as or similar to offer presentation module 114, in accordance with one or more implementations.

At an operation 304, the virtual reward associated with at least one of the presented offers may be incremented. The virtual currency associated with the presented offer may be incremented based on an amount of time elapsed since the virtual reward was first presented to the user, a number of views by the user of the presented offer, and/or other parameters. Operation 304 may be performed by a reward module that is the same as or similar to reward module 118, in accordance with one or more implementations.

At an operation 306, it may be determined if the offer has been accepted by the user. If the offer has not yet been accepted, the method moves on to step 308. If the offer has been accepted, the method proceeds to step 316, where the offer is removed from the offer wall and no longer presented of the user. Operations 306 and 316 may be performed by an offer presentation module that is the same as or similar to offer presentation module 114, in accordance with one or more implementations.

At an operation 308, it may be determined if the incremented virtual reward has reached a maximum reward threshold. In implementations, the maximum reward threshold may be different for each offer and for each user, different for each offer but the same for each offer across all users, different for each user but the same across all offers, or a combination thereof (e.g. some offers may have the same threshold across all users while other offer thresholds vary by user). Operation 308 may be performed by a reward module that is the same as or similar to reward module 118, in accordance with one or more implementations.

At an operation 310, responsive to a determination that the virtual reward has not reached the maximum reward threshold and upon further time elapsing, the user viewing the offer again, and/or other criteria, method 300 may return to operation 304 where the virtual reward for the offer may be incremented. Returning to operation 308, responsive to a determination of the virtual reward reaching the maximum reward threshold, at operation 312 an offer provider request may be transmitted to the offer provider associated with the offer having the virtual reward that reached the maximum reward threshold. The offer provider request may include a request for an increase in revenue from the offer provider that would be received from the game provider based on the user accepting the offer and performing the action associated with the offer. Operation 310 may be performed by a reward module that is the same as or similar to reward module 118, in accordance with one or more implementations. Operation 312 may be performed by a revenue module that is the same as or similar to revenue module 116, in accordance with one or more implementations.

At an operation 314, an offer provider acceptance may be received, increasing the revenue received from the offer provider associated with the offer based on the user accepting the offer and performing the action associated with the offer. Method 300 may then return to operation 304 where the virtual reward may be incremented. Operation 314 may be performed by a revenue module that is the same as or similar to revenue module 116, in accordance with one or more implementations.

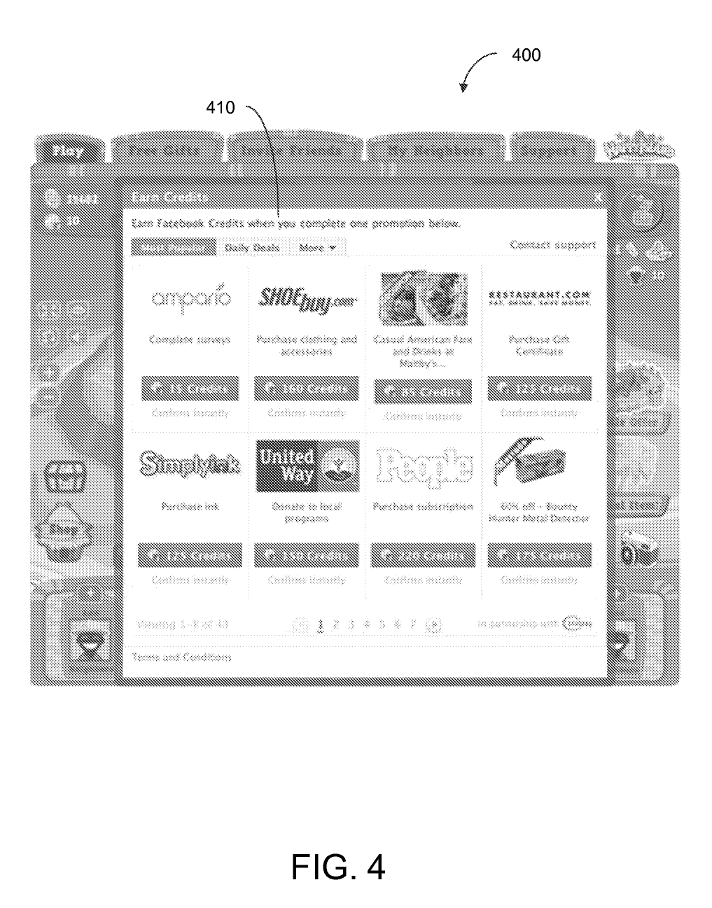

FIG. 4 depicts a screenshot 400 of a plurality of offers 410 being presented on an offer wall by an online game provider on a client computing device in accordance with one or more implementations.

Screenshot 400 may be presented on a user interface, such as in a webpage or mobile interface. The offers 410 presented to the users of the online game may include a number of different actions that can be performed by the users in exchange for virtual rewards. The offers 410 presented to the user may be provided by an entity providing services and/or products that the entity wants users to purchase or sample. An offer to try or purchase a product or service often has an accompanying benefit to the users of the online game who take up the offer, to encourage offer acceptance.

When a user completes an activity associated with an offer, the provider of the service and/or product associated with the offer may remit real word currency to an offer broker or other offer provider, and the user may receive an in-game reward from the online game provider. In implementations, the offers 410 presented to the user may include a first action having an associated first action and first reward of virtual currency usable in the virtual space. Responsive to the user performing the action to accept the offer, the user may be provided with the virtual currency associated with the reward, and the offer may be removed from the offer wall. In implementations, responsive to the user performing the action, an amount of revenue may be received by the online game provider from an offer provider associated with the accepted offer. Further, the offers 410 may be presented to the users on a per-user basis (i.e., the offers or some aspect of their presentation or associated rewards may vary from user to user).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for presenting offers for in-game virtual rewards, the system comprising:
one or more processors configured to execute computer program modules, the computer program modules comprising:
a space module configured to execute an instance of a virtual space, and to use the instance of the virtual space to facilitate interaction with the virtual space by users via client computing devices;
an offer reception module configured to receive information associated with one or more offers from one or more offer providers, the offers including a first offer from a first offer provider, the first offer being associated with a first action, a first reward of virtual currency usable in the virtual space, and a first amount of revenue;
an offer presentation module configured to effectuate presentation of the offers to a first user on a first client computing device;
a revenue module configured to receive revenue from the offer providers based on the users participating in the offers such that responsive to the first user accepting the first offer and performing the first action, the revenue module is configured to receive the first amount of revenue from the first offer provider; and
a reward module configured to determine the rewards of virtual currency associated with the offers on a per user basis such that the first reward of virtual currency is incremented until the first user accepts the first offer and performs the first action.

2. The system of claim 1, wherein the computer program modules further comprise a reward distribution module configured to distribute rewards to users for participating in the offers such that responsive to the first user accepting the first offer and performing the first action, the reward distribution module is configured to distribute the first reward to the first user.

3. The system of claim 1, wherein the revenue module is further configured to transmit users' indications of acceptance to offer providers such that responsive to the first user accepting the first offer an indication of acceptance of the first offer by the first user is transmitted to the first offer provider.

4. The system of claim 1, wherein the reward module is configured to increment the first reward based on at least one of an amount of time elapsed since the first reward was presented to the first user and a number of offer views by the first user.

5. The system of claim 1, wherein the reward module is further configured to stop incrementing the first reward once it reaches a maximum reward threshold.

6. The system of claim 5, wherein responsive to the first reward being incremented to reach the maximum reward threshold, the revenue module is configured to transmit an offer provider request to the first offer provider, the offer provider request including a request for an increase in revenue from the first offer provider based on the first user accepting the first offer and performing the first action.

7. The system of claim 6, wherein responsive to the revenue module transmitting the offer provider request, the revenue module is configured to receive an offer provider acceptance increasing the revenue received from the first offer provider based on the first user accepting the first offer and performing the first action.

8. The system of claim 7, wherein the reward module is configured to increase the maximum reward threshold responsive to receipt of the offer provider acceptance.

9. The system of claim 1, wherein the offer presentation module is configured to remove the first offer from the offers presented to the first user based on the first user participating in the first offer.

10. A method for presenting offers for in-game virtual rewards, the system comprising:
executing an instance of a virtual space, and using the instance of the virtual space to facilitate interaction with the virtual space by users via client computing devices;
receiving information associated with one or more offers from one or more offer providers, the offers including a first offer from a first offer provider, the first offer being associated with a first action, a first reward of virtual currency usable in the virtual space, and a first amount of revenue;
effectuating presentation of the offers to a first user on a first client computing device;
receiving revenue from the offer providers based on the users participating in the offers such that responsive to the first user accepting the first offer and performing the first action, the first amount of revenue is received from the first offer provider; and
determining the rewards of virtual currency associated with the offers on a per user basis such that the first reward of virtual currency is incremented until the first user accepts the first offer and performs the first action.

11. The method of claim 10, further comprising distributing rewards to users for participating in the offers such that responsive to the first user accepting the first offer and performing the first action, the first reward is distributed to the first user.

12. The method of claim 10, further comprising transmitting users' indications of acceptance to offer providers such that responsive to the first user accepting the first offer an indication of acceptance of the first offer by the first user is transmitted to the first offer provider.

13. The method of claim 10, further comprising incrementing the first reward based on at least one of an amount of time elapsed since the first reward was presented to the first user and a number of offer views by the first user.

14. The method of claim 10, further comprising stopping the incrementing of the first reward once it reaches a maximum reward threshold.

15. The method of claim 14, further comprising transmitting an offer provider request to the first offer provider including a request for an increase in revenue from the first offer provider based on the first user accepting the first offer and performing the first action, responsive to the first reward being incremented to reach the maximum reward threshold.

16. The method of claim 15, further comprising receiving an offer provider acceptance increasing the revenue received from the first offer provider based on the first user accepting the first offer and performing the first action, responsive to the revenue module transmitting the offer provider request.

17. The method of claim 16, further comprising increasing the maximum reward threshold responsive to receipt of the offer provider acceptance.

18. The method of claim 10, further comprising removing the first offer from the offers presented to the first user based on the first user participating in the first offer.
